(19) United States
(12) Patent Application Publication
(10) Pub. No.: US 2002/0164464 A1
(43) Pub. Date: Nov. 7, 2002

(54) Glossy inkjet coated paper

(76) Inventor: Sanjay A. Monie, Silver Spring, MD (US)

Correspondence Address: Westvaco Corporation, John Hopkins Road, Laurel, MD, 20723, US

(21) Appl. No.: 10/143,447

(22) Filed: May 11, 2002

Related U.S. Application Data
(62) Division of application No. 09/478,520, filed on Jan. 6, 2000.

(51) Int. Cl. B32B 3/00

(52) U.S. Cl. 428/195

(57) ABSTRACT

The inkjet recording sheet of the present invention comprises a cellulosic support, e.g., paper, having applied to at least one surface thereof one or more base coats, to provide a high absorption capacity for the applied inks, and an ink receptive top coat applied over the base coat(s) that is capable of being finished to a high gloss, comparable to a cast coated sheet, without sealing the surface.

### BACKGROUND OF INVENTION

The present invention relates generally to an inkjet recording sheet, and more particularly to an inkjet recording sheet having an ink receptive coating that is subject to being finished to a high gloss comparable to a cast coated sheet.

Paper for inkjet recording sheets used in inkjet printing must rapidly absorb the ink vehicle (e.g., water or solvent), to reduce drying time. Further, diffusion of ink laterally on the surface of the recording sheet must be prevented in order to achieve high resolution without bleeding or feathering. Moreover, a coated paper for inkjet printing should be able to achieve these results without any substantial dimensional changes. For this purpose, the base paper for inkjet sheets is generally made from bleached chemical pulp to which fillers, dyes, and if required, sizing agents and strength enhancers are added. An example of a typical base paper for use in the manufacture of an inkjet recording sheet is disclosed in U.S. Pat. No. 5,985,424 assigned to the present assignee herein.

It is also known that paper substrates for inkjet recording can be improved by applying a base coating to the paper surface before applying the ink receptive coating. Such base coats generally comprise a pigment and binder to produce a coated surface that has a porous structure with a large number of pores or voids. An example of a base coat for an inkjet recording sheet is also disclosed in U.S. Pat. No. 5,985,424.

Meanwhile, the ink receptive coatings for inkjet paper must provide a surface that is receptive to the inks used for printing. In the past, this result has been achieved through the use of high pigment-to-binder ratios, usually in combination with conventional pigments and other coating materials to provide a porous and permeable coating layer. However, because of the highly specific requirements for inkjet printing, conventional coating materials used in other printing processes generally are unsatisfactory for inkjet printing. This is especially true in the case of the development of inkjet recording paper for high quality printing, e.g., glossy inkjet paper that looks and feels like a photograph for producing near photographic images using OEM inkjet printers. In this regard, image quality is determined by the roundness, color uniformity and sharpness of the boundaries of the ink dots applied to the substrate substantially as disclosed in U.S. Pat. No. 4,877,686. In order to meet these requirements, new pigments and binders have been developed specifically for use in ink receptive coatings.

### SUMMARY OF INVENTION

It is a general object of the present invention to provide a high gloss inkjet recording sheet that has superior performance during inkjet printing.

More particularly, it is an object of the present invention to provide a high gloss inkjet recording sheet capable of use in OEM printers to make high quality prints with near photographic image quality.

In the past, cast coating has been utilized to make inkjet recording paper with a high gloss. This method has been practiced either using a pigmented coating as shown for example in U.S. Pat. Nos. 5,281,467; 5,397,619; 5,567,513; and 5,863,648, or with a polymeric coating as shown for example in U.S. Pat. Nos. 5,670,242 and 5,741,584 often with a base coat to provide drainage and curl control. The methods utilizing pigmented coatings employ for the most part silica pigments, and while such coatings yield a high gloss and a photographic feel upon cast coating, the ink dots applied to such sheets tend to be ill-defined and nonuniform in color and roundness. Meanwhile, the polymer based coatings used in cast coating typically produce good ink dot characteristics, but they are slow to dry yielding prints that are tacky to the touch and produce undue coalescence. However, because cast coating is a slow process which requires large capital and operating costs, there remains a need in the art to provide a high gloss inkjet recording sheet that can be manufactured by more conventional methods with the capability of producing photographic-like images for high quality printing. To satisfy this need, the inkjet recording sheet of the present invention was developed.

In accordance with the present invention, an inkjet recording sheet is prepared using an alkaline base paper that is size pressed to achieve suitable water resistance. In a preferred embodiment of the present invention, one or more base coatings and an ink receptive top coating are applied to one or both sides of the base paper. The top coating preferably includes a fumed (pyrogenic) alumina with polyvinyl pyrrolidone as the binder. The base coatings preferably comprise precipitated calcium carbonate and calcined clay pigments with polyvinyl acetate binder. Where a single base coating is employed, or in the case of double base coatings, the first applied, or lower base coat, may also contain silica to increase ink vehicle absorbency. Calendering such a product at high moisture yields a 60° sheet gloss of at least 60 as determined by ASTM Method D523 “Measurement of Specular Gloss”, which is comparable to a cast coated sheet. The finished sheets prepared in this manner have a DOI (Distinctness of Image) rating of at least 30, which is comparable to silver-halide glossy photographic paper. DOI is a measure of the reflective resolving power of a surface, and correlates closely with a photographic surface finish. The instrument used to measure this parameter (I²R Gloss Box “Distinctness of Image” Meter), consists of a light box with a test pattern of open circles of different sizes, ranked 10 for the largest and 100 for the smallest. The light box is mounted on a stand face-down, and the sheet to be tested is placed coated side up underneath the stand. The reflection of the incomplete circles on the sheet is viewed, and the value is reported as the smallest circle where it is still apparent that the circles are not closed. The smaller the circle (i.e., higher the value), the greater the reflective value of the coated surface. DOI correlates better with the subjective perception of gloss than the measurement of specular gloss. Such products have been found to be printable in all existing OEM desktop printers to yield high quality, photographic-like prints. The printed sheets are not tacky or rough to the touch, they are quick drying (less than 60 seconds), and the ink dots are round, with sharp boundaries and uniform color density.

As used in the present invention, fumed alumina is alumina that has been formed by the high temperature hydrolysis of gaseous aluminum trichloride so that it forms highly pure alumina particles. These particles have a nanometer scale primary particle size (average about 13 nm), with a very narrow particle size distribution. While these particles have no internal surface, they have a very high surface area-to-volume ratio and tend to have a specific surface area of about 75 m²/g. Unlike fumed silica, which has an anionic surface charge and which tends to be amorphous, fumed alumina has a cationic surface charge and is crystalline in form. The high specific surface area with a lot of accessible cationic sites helps to fix the anionic inkjet dyes and the crystalline nature of the particles contributes to the glossing potential of the coated surface. The use of fumed alumina in inkjet coatings is known as shown, for example, in U.S. Pat. No. 5,171,626, and is to be contrasted with the hydrated aluminas disclosed for use in inkjet coatings by the prior art for example in U.S. Pat. Nos. 5,635,291; 5,846,647; and 5,869,177.

### DETAILED DESCRIPTION

The base paper for the inkjet recording sheet of the present invention is preferably an alkaline paper having a basis weight in the range of 100-150 g/m² with a caliper of at least about 5.0 mil. It is prepared from a bleached wood pulp furnish to which is added a sizing agent such as alkylketene dimer, and fillers such as precipitated calcium carbonate and calcined clay. An example of a suitable precipitated calcium carbonate is ALBAGLOS supplied by Specialty Minerals. An example of a suitable calcined clay is ANSILEX supplied by Englehard Chemical Company. The base paper thus formed is preferably size pressed with a mixture of starch and styrene maleic anhydride in a conventional manner. Finished base paper properties (typical values) are, caliper greater than 5.0 mils, and preferably about 5-8 mils; TAPPI opacity of about 85-95%; TAPPI brightness of about 80-95%; Sheffield smoothness of about 150-300 seconds (units are approximately equivalent to cubic centimeters of air per minute times 10); and a Hercules size of about 300-900 seconds. This base paper is particularly advantageous for the novel inkjet sheet of the present invention because it provides exceptional dimensional stability during use.

The preferred base coatings for the inkjet recording sheet of the present invention are prepared from a formulation comprising a mixture of precipitated calcium carbonate (PCC) and calcined clay dispersed in a binder comprising polyvinyl acetate. The PCC pigment is incorporated into the coating formulation at a dry weight of from 40-60%. Calcined clay is incorporated into the coating formulation at a dry weight of from about 20-30%. Up to about 25 parts of the calcium carbonate may be replaced with silica gel W-300 (supplied by Grace Company), or precipitated silica FK-310 (supplied by Degussa). When more than one base coating is used, only the first applied or lower based coat preferably includes silica. The addition of silica improves the drying time of the ink and provides increased ink density. Typical binders for the base coating include polyvinyl acetate (about 10-15%), an example of which is Vinac 848 supplied by Air Products or other suitable binders such as polyvinyl alcohol. In addition to these basic ingredients, there may be added sufficient ammonium hydroxide to dissolve the protein and a thickener such as ALCOGUM L28 (supplied by Alco Chemical Company) to reach the target viscosity. A viscosity in the range of from about 3000-4000 centipoise Brookfield (20 rpm, No. 4 spindle) is preferred at a solids content of about 50-60%. The base coating or coatings are applied to the paper to achieve a total coat weight within the range of about 7-20 lbs/ream (ream size 3300 ft²), each side using any conventional coating device known to those skilled in the art (blade coater preferred). The base coatings prepared as described above are particularly advantageous because of their enhanced absorptivity.

The ink receptive coating for the inkjet recording paper of the present invention is applied directly over, the base coat or coatings. It is designed to provide a high glossing surface yielding superior printed images. The ink receptive coating is prepared from a formulation comprising fumed (pyrogenic) alumina with a nanometer scale particle size of 50-100 nm and a very narrow particle size distribution. Up to 40% of the fumed alumina may be replaced with cationic colloidal silica (e.g., Eka Bindzil-Cat 80); alumina hydrate (e.g., Alcoa Hydral Coat); or, boehmite alumina (e.g., Alcoa HiQ-40). These pigment components are dispersed in a binder consisting essentially of polyvinyl pyrrolidone (e.g., ISP PVP K-60). Other suitable ink receptive coating binders comprise partially or fully hydrolyzed, low-to-medium molecular weight polyvinyl alcohols (e.g., Air Products 107, 203, 205 or 310). The binder is added at a level of between about 5-10 parts on 100 parts pigment.

The water fastness and image color accuracy of the ink receptive coating can be enhanced by the addition of up to 5 parts (based on 100 parts pigment) of a polycationic material such as poly-DADMAC (e.g., Nalco 7544). If necessary, the coating can be thickened with suitable thickeners such as CMC or hydroethyl-cellulose (e.g., National 250 MR) to achieve a viscosity appropriate for the coating method employed.

The ink receptive top coating can be applied using air-knife, flexography, or rod/blade metering at a coat weight of between about 2-6 lbs/ream (ream size 3300 ft²). The targeted sheet moisture after coating is between about 4-8%. The final sheet is glossed by finishing in a super calender device at high moisture (6-8%), at a load of about 600-800 pli, 110-300 ° F. hot roll temperature, one-to-six nips, at a speed of from 100-450 fpm.

Inkjet recording sheets prepared in accordance with the foregoing description have been found to provide superior performance with a variety of inkjet inks and inkjet printers. In addition, as demonstrated by the results shown in the following table, the DOI of the inkjet recording sheet of the present invention identified as “Prototype” is equivalent to typical glossy photographic papers presently on the market and to the best cast coated inkjet products current available.

| Sample | 60% Gloss | DOI |
|---|---|---|
| PROTOTYPE | 61 | 30 |
| Inkjet Paper | | |
| HP Premium Photo | 91 | 20 |
| Konica Photo Glossy (cast coated) | 90 | 30 |
| Kodak Inkjet Photo | 80 | 10 |
| Great White Glossy Photo | 80 | 0 |
| Hammermill Jet Print Ultragloss | 68 | 0 |
| Hammermill Jet Print Photo | 84 | 20 |
| Canon Glossy Photo | 24 | 0 |
| Epson Photo Quality Glossy | 41 | 0 |
| Avery Glossy Photo Quality | 44 | 0 |
| Computjet Photo Glossy | 54 | 0 |
| IBM Gloss Coated | 66 | 10 |
| IBM Digital Photo | 64 | 10 |
| Xerox Photo Gloss | 89 | 20 |
| Champion Inkjet High Gloss | 88 | 10 |
| Lexmark Inkjet Photo (cast coated) | 30 | 30 |
| Comp USA Inkjet Photo | 66 | 20 |
| Photographic Papers | | |
| Kodak Porta Glossy | 80-93 | 30 |
| Kodak Supra Glossy | 80-91 | 30 |
| Kodak Ultra Glossy | 90 | 30 |

Since only a preferred embodiment of the present invention has been fully disclosed herein, those skilled in the art will understand that various changes and modifications may be made in the invention as disclosed without departing from the spirit of the invention as defined in the appended claims.

What is claimed is:

1. A process for producing a glossy inkjet recording sheet which comprises:
(a) applying onto at least one surface of a paper substrate a first base coating consisting essentially of pigment and binder;
(b) applying over said first base coating an ink receptive coating consisting essentially of pigment and binder; and,
(c) finishing the coated surface to achieve a 60 degree gloss of at least about 60 as measured by the ASTM Method D523 and a Distinctness of Image (DOI) of at least about 30.

2. The process of claim 1 wherein up to about 25 parts by weight of silica gel is included in the first base coating for improved absorptivity of the applied inks.

3. The process of claim 1 wherein a second base coating is applied over the first base coating before the application of the ink receptive coating.

4. The process of claim 3 wherein up to about 25 parts by weight of precipitated silica is included in the first base coating only for improved absorptivity of the applied inks.

5. A process for producing a glossy inkjet recording sheet comprising:
(a) selecting as a substrate an alkaline paper having a basis weight in the range of 100-150 g/m² and a caliper of at least about 5.0 mil;
(b) applying to at least one surface of the substrate of step (a) a first base coating comprising essentially precipitated calcium carbonate and calcined clay dispersed in a binder at a concentration of about 10-15% binder;
(c) applying over the base coating of step (b) an ink receptive top coating comprising essentially fumed alumina having a primary particle size on the order of about 13 nanometers and a specific surface area less than about 75 m²/g dispersed in a binder at a concentration of about 5-10% binder; and,
(d) finishing the coated substrate of step (c) in a calender device at a moisture content of from about 6-8%, a nip load of from about 600-800 pli, with a hot roll temperature of from about 100-200 degrees F., one-to-six nips to achieve a finished surface having a 60° gloss of at least about 60 according to ASTM Method D523 and a Distinctness of Image (DOI) measurement of at least about 30.

6. A glossy inkjet recording sheet comprising as the substrate, paper, having applied to at least one surface thereof a first base coating comprising essentially precipitated calcium carbonate and calcined clay dispersed in binder at a concentration of about 10-15% binder, and an ink receptive top coating applied over said base coating comprising essentially fumed alumina having a primary particle size on the order of about 13 nanometers and a specific surface area less than about 75 m²/g dispersed in a binder at a concentration of about 5-10% binder, wherein the finished coated surface of said recording sheet has a 60° gloss of at least about 60 according to ASTM Method D523 and Distinctness of Image (DOI) measurement of at least about 30.

7. The inkjet recording sheet of claim 6 wherein up to 25 parts by weight of the calcium carbonate pigment in the first base coat is replaced with silica.

8. The inkjet recording sheet of claim 6 wherein a second base coating is applied over said first base coating and up to 25 parts by weight of the calcium carbonate pigment in the first base coat is replaced with silica.
